(19) United States
(12) Patent Application Publication
(10) Pub. No.: US 2011/0069515 A1
(43) Pub. Date: Mar. 24, 2011

(54) ACTIVE BOOST POWER CONVERTER FOR SINGLE-PHASE SRM

(75) Inventors: Jianing LIANG, Zhuhai City (CN); Jin Woo AHN, Busan (KR); Dong Hee LEE, Busan (KR)

(73) Assignee: KYUNGSUNG UNIVERSITY INDUSTRY COOPERATION FOUNDATION, Busan (KR)

(21) Appl. No.: 12/883,598

(22) Filed: Sep. 16, 2010

(30) Foreign Application Priority Data
Sep. 21, 2009 (KR) 10-2009-0088854

(51) Int. Cl. H02M 7/06

(52) U.S. Cl. 363/126

(57) ABSTRACT

Disclosed is an active boost power converter for driving a single-phase SRM, capable of rapidly establishing excitation current in the excitation mode and reducing tail current and negative torque in the demagnetization mode under the high-speed operation of the SRM. The active boost power converter includes a boost module and a converter module connected to the boost module. The boost module includes first and second capacitors, first and second diodes and a switch device turned on/off to connect the first and second capacitors to each other in series or parallel. The switch device includes an insulated gate bipolar transistor (IGBT). The power converter is operated with first and second input modes and first and second output modes. Voltage of the first capacitor is equal to dc-link voltage and first and second capacitors are controlled to be operated in series or parallel by simply controlling the IGBT.

### BACKGROUND OF THE INVENTION

1. Field of the Invention

The present invention relates to an apparatus for driving a switched reluctance motor (hereinafter, referred to as SRM). More particularly, the present invention relates to an active boost power converter for driving a single-phase SRM, capable of improving the driving characteristic of the SRM upon the high-speed driving of the SRM.

2. Description of the Related Art

An SRM has been extensively used in various industrial fields due to the simple mechanical structure and the low manufacturing cost thereof. The SRM has the strong mechanical structure and can be operated in the wide speed range with the high output ratio, so the SRM can be operated at the high-speed.

Meanwhile, a four-level converter has been suggested for the high-speed operation of the SRM.

FIGS. 1A to 1D are circuit views showing the operation modes of a four-level converter employed in a conventional SRM driving apparatus.

Referring to FIGS. 1A to 1D, the four-level converter additionally includes a boost capacitor C_{CD}, a power switch Q_{CD}, and a diode D_{CD}, when comparing with an asymmetric bridge converter. The boost capacitor C_{CD} is connected to a capacitor C_{DC} in series and stores magnetic energy during the turn-off state of a phase switch. At this time, regenerative energy is partially stored in the boost capacitor C_{CD}, so that addition boost voltage is established.

As shown in FIGS. 1A to 1D, the four-level converter has four operation modes including a fast excitation mode, an excitation mode, a wheeling mode and a fast demagnetization mode. In the case of the fast excitation mode shown in FIG. 1A, overlap voltage of two capacitors C_{CD} and C_{DC} rapidly establishes excitation current to reduce the lead angle. In addition, in the case of the demagnetization mode shown in FIG. 1D, overlap voltage generates fast demagnetization current to reduce the negative torque and tail current, thereby improving the dynamic characteristic of the SRM.

However, the four-level converter discharges energy stored in the boost capacitor C_{CD} only in the fast excitation mode. Thus, current ripple is increased at the low-speed operation. In addition, the four-level converter requires a voltage detection circuit for controlling the boost voltage, a complicated boost control scheme and additional circuits in order to stably maintain the voltage.

### SUMMARY OF THE INVENTION

Accordingly, the present invention has been made keeping in mind the above problems occurring in the prior art, and an object of the present invention is to provide an active boost power converter for driving a single-phase SRM, capable of rapidly establishing excitation current in the excitation mode and reducing tail current and negative torque in the demagnetization mode under the high-speed operation of the SRM.

In order to accomplish the above object, there is provided an active boost power converter including a boost module connected to a rectifying module that rectifies AC power and a converter module connected to the boost module, wherein the boost module includes first and second capacitors, first and second diodes and a switch device turned on/off to connect the first and second capacitors to each other in series or parallel.

The switch device includes an insulated gate bipolar transistor (IGBT), which is an active switch device.

The switch device further includes a third diode, which connects the second capacitor to the first capacitor in series when the switch device is in a turn-off state, and the power converter is operated with first and second input modes and first and second output modes.

The first capacitor is charged through a first section in the first input mode, the second diode is turned-on in the second input mode, the first and second capacitors are connected to each other in series to be charged with input current, and overlap voltage is input into a second section.

The first and second capacitors and the first and second diodes are operated as two independent power sources connected in parallel to each other in the first output mode, output voltage of the second section is equal to maximum voltage of the two independent power sources, the switch device is turned-on in the second output mode so that the first and second capacitors are connected to each other in series, and output voltage of the second section is overlapped.

When the converter module is operated with an excitation mode and the first and second capacitors are connected in parallel to each other under a turn-off state of the switch device, phase voltage is determined depending on voltage having a higher level between voltages of the first and second capacitors.

When the converter module is operated with a demagnetization mode and the first and second capacitors are connected to each other in series under a turn-off state of the switch device, voltage applied to a phase winding corresponds to dc-link voltage in the excitation mode and a double of the dc-link voltage in the demagnetization mode.

The first and second capacitors are connected to each other in series when the switch device is turned-on and the overlap voltage of the second section generates fast excitation current.

As described above, according to the present invention, the boost module is provided to make voltage of the first capacitor equal to dc-link voltage and first and second capacitors are controlled to be operated in series or parallel by simply controlling the IGBT, so that high excitation voltage is applied to rapidly establish excitation current in the excitation mode and high demagnetization voltage is applied to reduce tail current and negative torque in the demagnetization mode. Therefore, the present invention can improve the torque characteristics of the SRM while improving the output ratio, thereby enhancing the efficiency of the SRM.

According to the present invention, the efficiency of the SRM can be improved through the fast demagnetization in the demagnetization period and the fast response characteristic can be achieved by applying the high excitation current in the excitation period.

### BRIEF DESCRIPTION OF THE DRAWINGS

The above and other objects, features and other advantages of the present invention will be more clearly understood from the following detailed description when taken in conjunction with the accompanying drawings, in which:

FIGS. 1A to 1D are circuit views showing the operation modes of a four-level converter employed in a conventional SRM driving apparatus;

FIG. 2 is a circuit view showing the structure of an SRM driving apparatus according to the exemplary embodiment of the present invention;

FIGS. 3A to 3D are circuit views showing the operation modes of a boost module shown in FIG. 2;

FIGS. 4A to 4F are circuit views showing the operation modes of a boost module and a converter module shown in FIG. 2;

FIG. 5 is a graph showing an inductance profile of an SRM shown in FIG. 2;

FIG. 6A is a graph showing the simulation result of an SRM driving apparatus equipped with an asymmetric bridge converter;

FIGS. 6B and 6C are graphs showing the simulation result of an SRM driving apparatus equipped with a boost module under the on-state and off-state of an IGBT, respectively; and

FIG. 7 is a graph showing the flux and current trace of an SRM driving apparatus shown in FIGS. 6A to 6C.

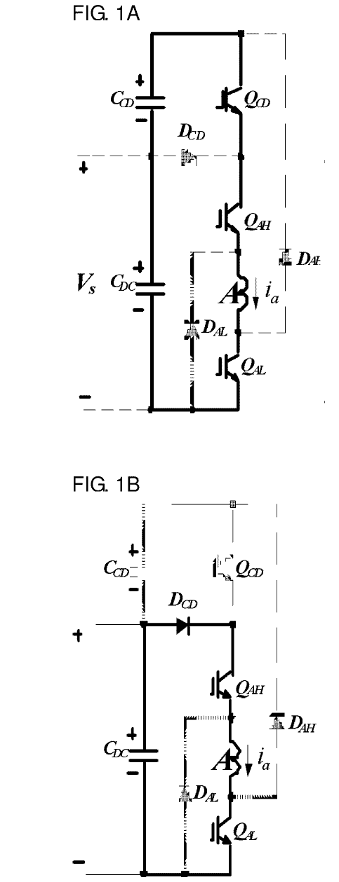

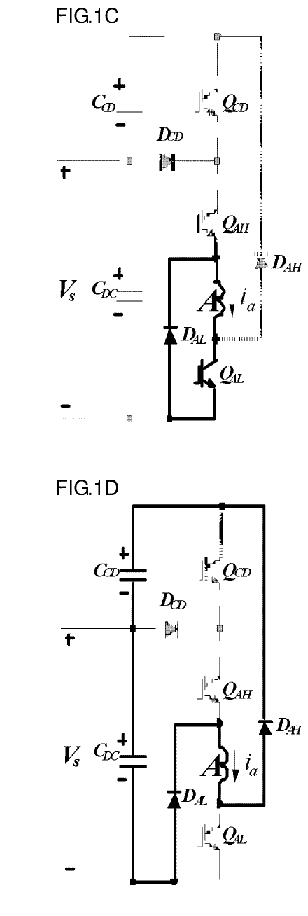

### DETAILED DESCRIPTION OF THE INVENTION

Hereinafter, a single-phase SRM driving apparatus according to the exemplary embodiments of the present invention will be described in detail with reference to accompanying drawings.

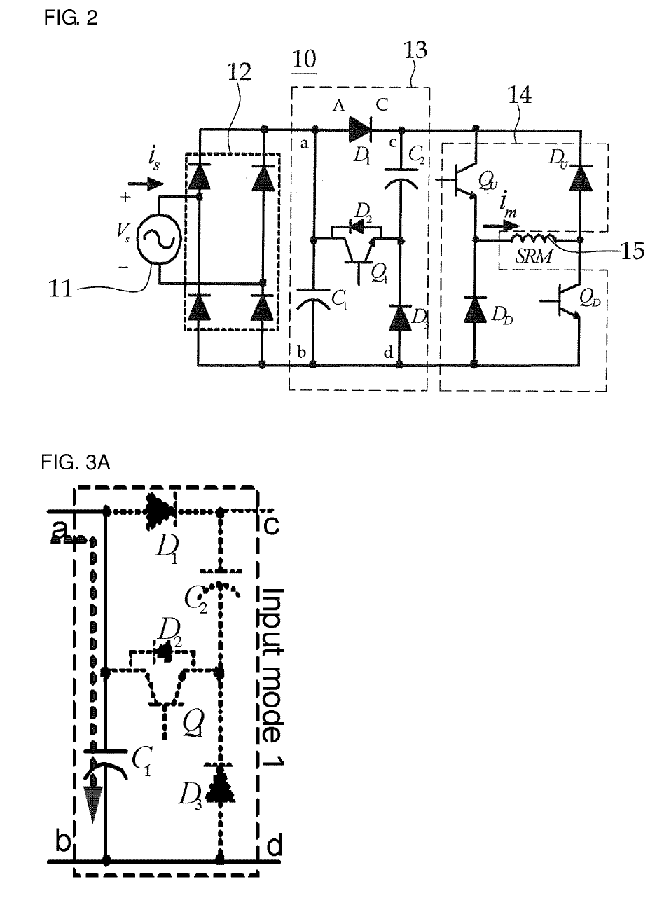

FIG. 2 is a circuit view showing the structure of the SRM driving apparatus according to the exemplary embodiment of the present invention.

In this embodiment, for example, the single-phase SRM driving apparatus, which drives an SRM by applying single-phase AC power, will be described.

The SRM driving apparatus 10 for driving an SRM 15 includes a power source 11 for supplying single-phase AC power, a rectifying module 12 including a bridge rectifying circuit to smooth the power supplied from the power source 11, a boost module 13 connected to the rectifying module 12, and a converter module 14 including an asymmetric bridge converter.

The boost module 13 includes first and second capacitors C1 and C2, first and third diodes D1 and D3, and an insulated gate bipolar transistor Q1 (hereinafter, referred to as IGBT). The first and second capacitors C1 and C2 are provided in first and second sections ab and cd such that they are connected in parallel to each other. The first diode D1 is provided between a node a and a node c, and the third diode D3 has an anode terminal connected to a node d and a cathode terminal connected to the second capacitor C2. The IGBT Q1 is connected between the first section ab and the second section cd. If the IGBT Q1 is turned-on, the first and second capacitors C1 and C2 are connected to each other in series. In addition, if the IGBT Q1 is turned-off, the first and second capacitors C1 and C2 are connected to each other in parallel. Further, the boost module 13 includes a second diode D2 between an emitter terminal and a collector terminal of the IGBT Q1 to alloy the current to flow through the second section cd when the IGBT Q1 is turned off.

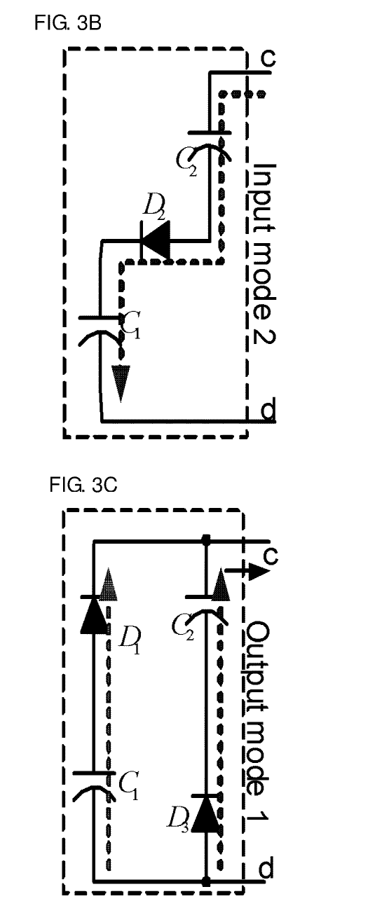

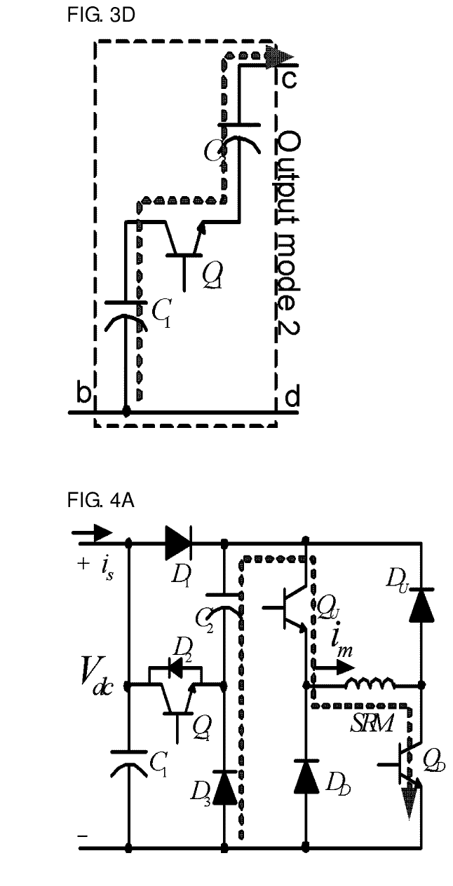

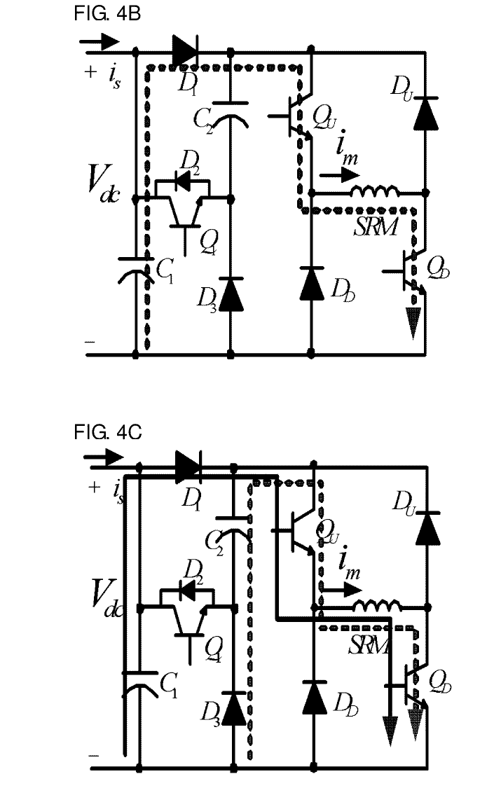

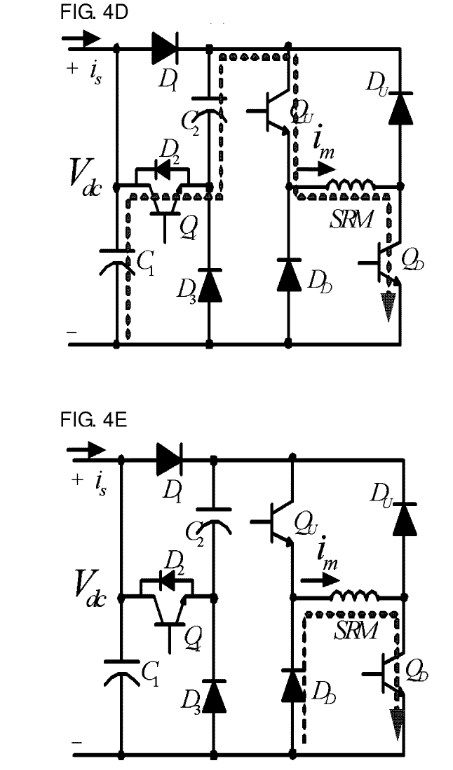

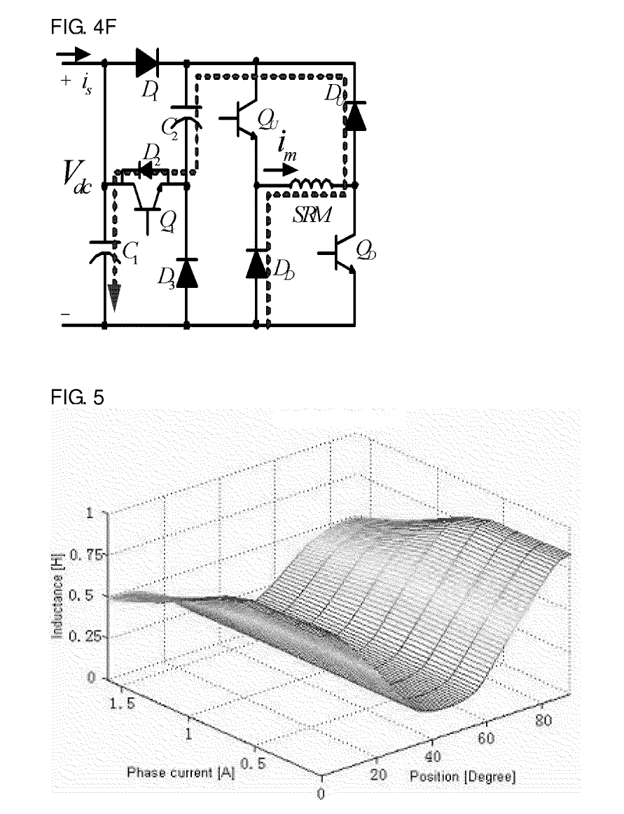

Hereinafter, the operation of the SRM driving apparatus having the above structure according to the exemplary embodiment of the present invention will be described in detail with reference to FIGS. 3A to 3D and 4A to 4F.

FIGS. 3A to 3D are circuit views showing the operation modes of the boost module 13 shown in FIG. 2 and FIGS. 4A to 4F are circuit views showing the operation modes of the boost module 13 and the converter module 14 shown in FIG. 2.

First, the operation modes of the boost module 13 will be described with reference to FIGS. 3A to 3D.

As shown in FIGS. 3A to 3D, the operation modes of the boost module 13 include first and second input modes and first and second output modes.

In the case of the first input mode shown in FIG. 3A, the capacitor C1 is charged with energy supplied from the power source 11 through the first section ab. At this time, voltage of the first capacitor C1 is substantially identical to the power, which is supplied from the power source 11 and rectified by the rectifying module 12.

In the case of the second input mode shown in FIG. 3B, the energy is input through the second section cd so that the second diode D2 is turned-on. Thus, the first and second capacitors C1 and C2 are connected to each other in series and charged with input current, and overlap voltage is input into the second section cd.

In the case of the first output mode shown in FIG. 3C, the first and second capacitors C1 and C2 and the first and third diodes D1 and D3 constitute two independent voltage sources connected in parallel to each other, and output voltage of the second section cd is equal to maximum voltage of the independent voltage source.

In the case of the second output mode shown in FIG. 3D, the IGBT Q1 is turned-on, so that the first and second capacitors C1 and C2 are connected to each other in series and the output voltage of the second section cd is overlapped.

Hereinafter, the operation modes of the SRM driving apparatus 10 will be described with reference to FIGS. 4A to 4F.

As shown in FIGS. 4A to 4F, the SRM driving apparatus has six operation modes including a first capacitor excitation mode, a second capacitor excitation mode, a first and second capacitor excitation mode, a fast excitation mode, a wheeling mode and a fast demagnetization mode.

When the IGBT Q1 is in the turn-off state as shown in FIG. 4C, the converter module 13 is operated with the excitation mode and the first and second capacitors C1 and C2 are connected in parallel to each other. At this time, the phase voltage is determined depending on the voltage having a higher level between voltages of the first and second capacitors C1 and C2. In addition, in the case of the demagnetization mode shown in FIG. 4F, the first and second capacitors C1 and C2 are connected to each other in series. Thus, dc-link voltage is applied to the phase winding of the SRM 15 in the excitation mode. In addition, the double of the dc-link voltage is applied to the phase winding of the SRM 15 in the demagnetization mode.

In contrast, when the IGBT Q1 is in the turn-on state, as shown in FIG. 4D, the first and second capacitors C1 and C2 are connected to each other in series, and the overlap voltage establishes fast excitation current.

Therefore, according to the present invention, the efficiency of the SRM and the torque characteristic can be improved through the fast demagnetization in the demagnetization period. In addition, since the higher excitation current is applied in the excitation period, the fast response characteristic can be achieved.

FIG. 5 is a graph showing an inductance profile of the SRM 15 shown in FIG. 2. The graph represents the simulation result obtained by using Matlab/Simulink to prove the characteristic of the SRM driving apparatus 10.

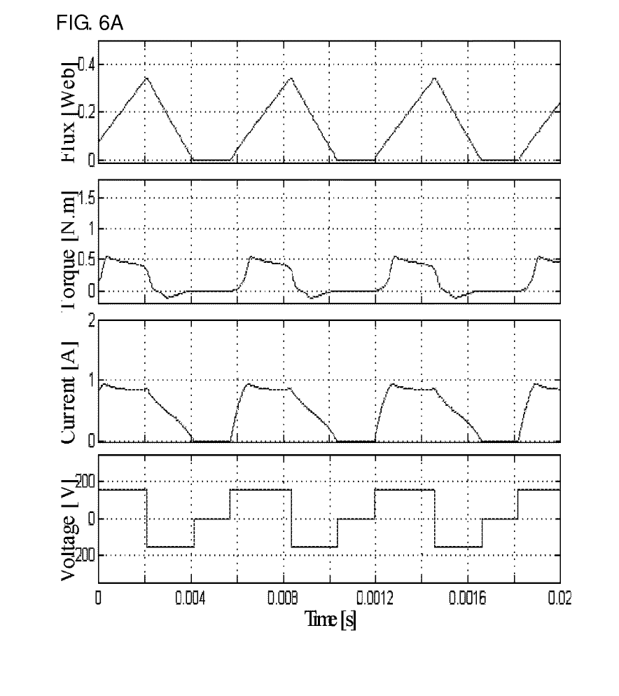

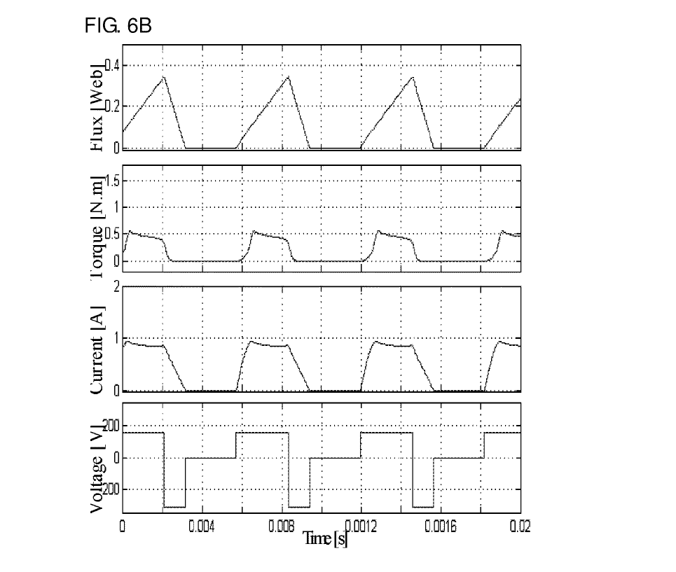

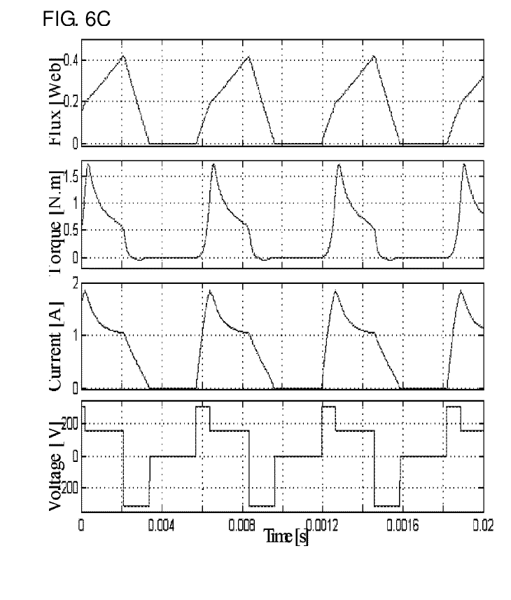

FIG. 6A is a graph showing the simulation result of the SRM driving apparatus 10 equipped with an asymmetric bridge converter, and FIGS. 6B and 6C are graphs showing the simulation result of the SRM driving apparatus 10 equipped with the IGBT Q1 under the on-state and off-state of the IGBT Q1, respectively.

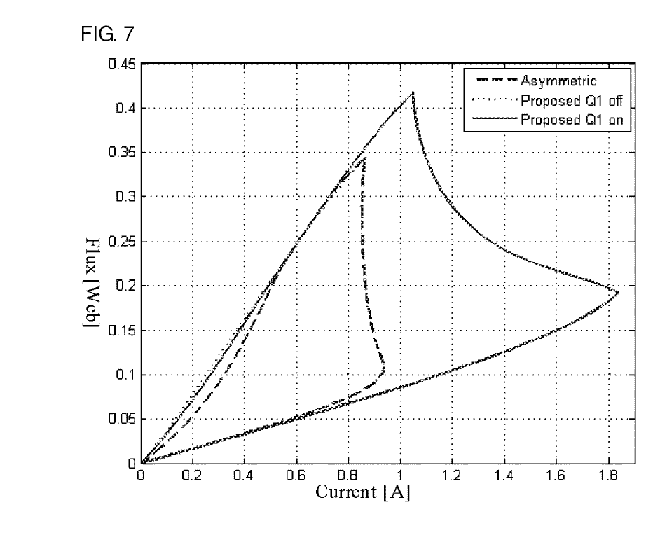

In addition, FIG. 7 is a graph showing a flux and a current trace of the SRM driving apparatus 10 shown in FIGS. 6A to 6C.

Referring to the simulation results shown in the above drawings, when the IGBT Q1 is in the turn-off state, the tail current and the negative torque are reduced due to the higher demagnetization voltage of the SRM driving apparatus 10. In contrast, when the IGBT Q1 is in the turn-on state, the first and second capacitors C1 and C2 are connected to each other in series, so that the double of the dc-link voltage is applied to the phase winding, thereby rapidly establishing the current. In addition, the output of the SRM 15 can be increased under the same turn-on angle and turn-off angle.

As can be seen from the increased region in the flux-current trace shown in FIG. 7, the output is increased through the boost module 13 by two times as compared with that of the SRM driving apparatus equipped with the asymmetric bridge converter.

As mentioned above, according to the present invention, the boost module is provided to make voltage of the first capacitor equal to dc-link voltage and first and second capacitors are controlled to be operated in series or parallel by simply controlling the IGBT, so that high excitation voltage is applied to rapidly establish excitation current in the excitation mode and high demagnetization voltage is applied to reduce tail current and negative torque in the demagnetization mode.

Although exemplary embodiments of the present invention has been described for illustrative purposes, those skilled in the art will appreciate that various modifications, additions and substitutions are possible, without departing from the scope and spirit of the invention as disclosed in the accompanying claims.

What is claimed is:

1. An active boost power converter comprising:
a boost module connected to a rectifying module that rectifies AC power; and
a converter module connected to the boost module,
wherein the boost module includes first and second capacitors, first and second diodes and a switch device turned on/off to connect the first and second capacitors to each other in series or parallel.

2. The active boost power converter of claim 1, wherein the switch device includes an insulated gate bipolar transistor (IGBT), which is an active switch device.

3. The active boost power converter of claim 2, wherein the switch device further includes a third diode, which connects the second capacitor to the first capacitor in series when the switch device is in a turn-off state, and the power converter is operated with first and second input modes and first and second output modes.

4. The active boost power converter of claim 3, wherein the first capacitor is charged through a first section in the first input mode, the second diode is turned-on in the second input mode, the first and second capacitors are connected to each other in series to be charged with input current, and overlap voltage is input into a second section.

5. The active boost power converter of claim 3, wherein the first and second capacitors and the first and second diodes are operated as two independent power sources connected in parallel to each other in the first output mode, output voltage of the second section is equal to maximum voltage of the two independent power sources, the switch device is turned-on in the second output mode so that the first and second capacitors are connected to each other in series, and output voltage of the second section is overlapped.

6. The active boost power converter of claim 3, wherein, when the converter module is operated with an excitation mode and the first and second capacitors are connected in parallel to each other under a turn-off state of the switch device, phase voltage is determined depending on voltage having a higher level between voltages of the first and second capacitors.

7. The active boost power converter of claim 3, wherein, when the converter module is operated with a demagnetization mode and the first and second capacitors are connected to each other in series under a turn-off state of the switch device, voltage applied to a phase winding corresponds to dc-link voltage in the excitation mode and a double of the dc-link voltage in the demagnetization mode.

8. The active boost power converter of claim 4, wherein the first and second capacitors are connected to each other in series when the switch device is turned-on and the overlap voltage of the second section generates fast excitation current.
